(19) United States
(12) Patent Application Publication
(10) Pub. No.: US 2008/0284667 A1
(43) Pub. Date: Nov. 20, 2008

(54) Modification of antenna radiation pattern using loading elements

(75) Inventor: Sean Russell Mercer, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/804,482

(22) Filed: May 18, 2007

(51) Int. Cl. H01Q 9/00

(52) U.S. Cl. 343/749

(57) ABSTRACT

Described is a technology by which an antenna circuit is modified by changing its loading element or elements to thereby provide a particular polar radiation/gain pattern. An antenna loading element is coupled to an antenna (e.g., a chip antenna of a mobile device, a printed copper monopole antenna, a meander line antenna, a Planar Inverted-F (type) Antenna (PIFA) or the like), and includes at least one segment that is not substantially parallel to the chip antenna. For example, in one implementation, the antenna element includes segments that are substantially orthogonal to a top-loaded chip antenna. The resulting antenna/antenna circuit modifies the polar radiation pattern, such that, for example, a mobile device can achieve more optimum gain when oriented for typical usage. One or more other segments may be bent to extend at another angle or angles to achieve a particular polar gain pattern.

### BACKGROUND

Many contemporary computing devices are equipped with small antennas in the form of chip antenna implementations and other antenna (e.g., printed copper monopole antennas and Planar Inverted-F (type) Antenna, or PIFA) implementations. For example, handheld computing devices, such as operating at 2.45 Gigahertz (e.g., WiFi, Bluetooth® and ZigBee™ radios) fall into this category. Other devices such as mobile telephones, media players and so forth may also benefit from chip antenna implementations.

The size of the ground plane, and ground plane cut out for the chip antenna, strongly influence the gain and radiation pattern of the antenna. Size, mechanical and cosmetic constraints often result in a suboptimal antenna environment in handheld devices. As a result, small antennas including chip antennas often have polar gain patterns with deep nulls.

Various attempts have been made to enhance the gain on such devices. However, because of the polar patterns, devices can exhibit good gain in one orientation, and poor gain, resulting in a lost or degraded link or connection, in other orientations.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an antenna loading element is coupled to an antenna (e.g., a chip antenna of a mobile device), in which the loading element includes at least one loading element portion (e.g., segment) that is not substantially parallel to the chip antenna. For example, in one implementation, the antenna element includes one or more segments that are substantially orthogonal to the antenna. The resulting antenna/antenna circuit modifies the polar radiation pattern, such that, for example, a mobile device can achieve more optimum gain when oriented for typical usage.

In one example, the antenna element includes a portion that is substantially parallel to the antenna, and at least one other portion that is substantially orthogonal to the antenna. For example, when the antenna element is located on a printed circuit board that generally defines an x-y plane, the antenna and a first loading portion of the antenna element are generally parallel to the y-direction, while one segment extends generally in the negative x-direction, and another segment extends generally in the positive y-direction. Another segment may be bent to extend at another angle, e.g., partially in the negative or positive y-direction and partially in the negative or positive x-direction.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an example representation of a top loading antenna circuit implementation.

FIG. 2 shows an example representation of a top loading antenna circuit implementation modified with additional loading elements.

FIG. 3 shows an example representation of a top loading antenna circuit implementation modified with additional loading elements including an additional segment.

FIG. 4 shows an example representation of the top loading antenna circuit implementation modified with additional loading elements when located on an example circuit board.

FIG. 5 is a representation of polar pattern measurements showing comparisons between the top-loading antenna circuit of FIG. 1 and the modified top-loading antenna circuit of FIG. 2 when the circuit is oriented horizontally and rotated to obtain gain measurements at various angles.

FIG. 6 is a representation of polar pattern measurements showing comparisons between the top-loading antenna circuit of FIG. 1 and the modified top-loading antenna circuit of FIG. 2 when the circuit is oriented vertically and rotated to obtain gain measurements at various angles.

FIG. 7 is an example representation of a handheld device that may benefit from a modified top loading antenna circuit when oriented for normal usage.

FIG. 8 is an example block diagram representing components of an illustrative handheld device that may benefit from a modified top loading antenna circuit.

### DETAILED DESCRIPTION

Various aspects of the technology described herein are generally directed towards modifying an antenna circuit by including an additional loading (radiating) element to provide a resulting antenna that significantly alters the gain polar pattern. In one example, the modification is to a top-loaded chip antenna, where top loading generally corresponds to extending the length of the antenna element with printed copper on a printed circuit board, where the length is extended parallel to the y-axis; (note that as used herein, the printed circuit board can be considered as generally defining an x-y plane). Further, note that top loading has been described as enhancing the gain of a physically small chip antenna element, but does not address the antenna polar pattern.

For purposes of understanding, the technology is described herein by use of examples, including those that make modifications relative to a top-loaded chip antenna. However, as will be understood, these are only non-limiting examples, and the technology is applicable to different types of antenna implementations, as well as to a virtually unlimited number of ways to add, position and/or otherwise modify an antenna loading element (and/or the corresponding ground plane). For example, substantially orthogonal element portions are described with respect to modifying a top loading element, but a bottom loading element may modified, with or without a top loading element. Further, the technology may be applied to any frequency, including but not limited to a 2.45 Gigahertz antenna configuration used in some actual implementations.

Moreover, while a chip antenna is primarily described herein, the polar patterns of other antenna topologies may be modified via the technology described herein, including by using substantially orthogonal element portions and/or other loading element portions. For example, a printed (copper) monopole antenna may have a loading element positioned at one end or the other (or both) to modify its polar pattern; a monopole antenna may also be implemented as a metal ‘stick’-type form protruding from another assembly. A meander line antenna may also be modified by adding a loading element thereto. A Planar Inverted-F (type) Antenna (PIFA) will have its polar pattern altered if one end of the long arm is angled substantially orthogonal or otherwise angled relative to the main orientation. A PIFA can be fabricated by printing the structure in the copper on a printed circuit board, generally resembling an upper case letter ‘F’ in its side, with a (e.g., fifty Ohm) feed point at the far tip of the leg protruding from the middle of the long side of the F and the tip of the top leg of the F connected to ground. For example, the long side that may be modified may be the segment below the center line. A PIFA also may be arranged as a three-dimensional structure, with the same electrical connections but with the metal structure positioned above a printed circuit board and having a ground plane below it (or vice-versa). In general, the technology described herein applies to any type of antenna that has a modified element for the purpose of more optimally positioning the orientation for best gain relative to a likely physical orientation.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in wireless communication in general.

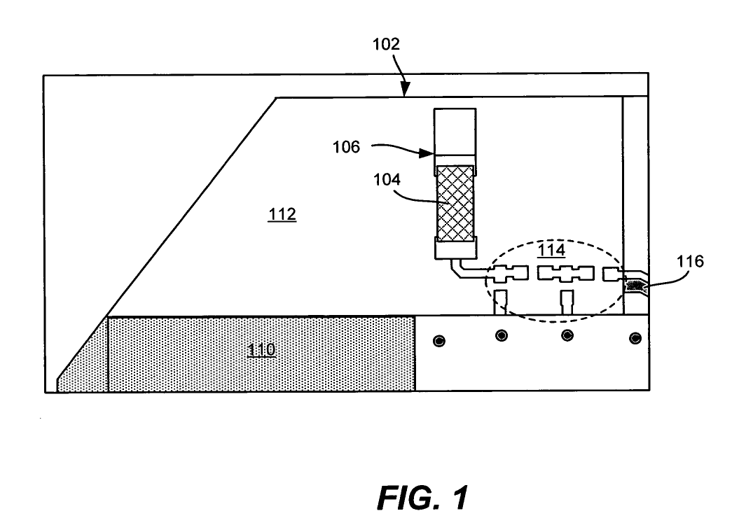

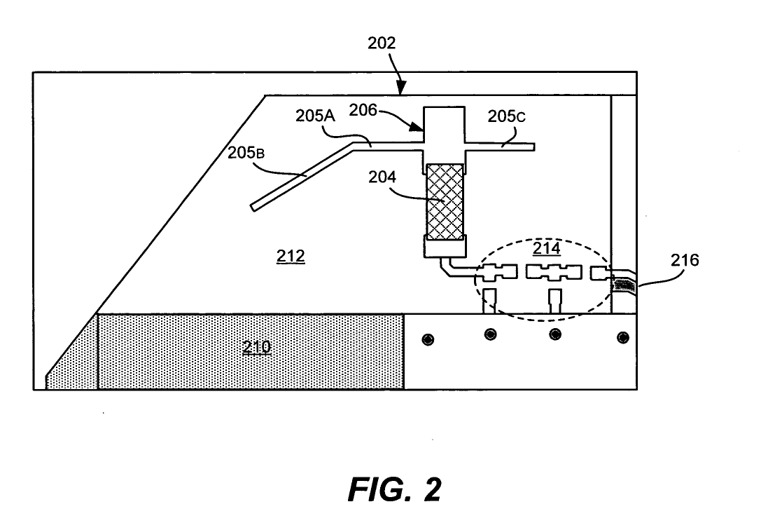

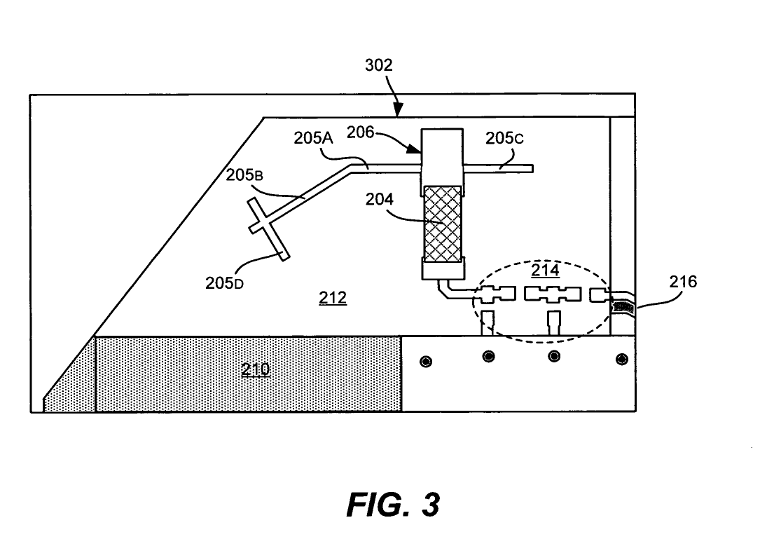

Turning to FIG. 1, there is shown a top loading antenna circuit 102, including a chip antenna 104 and a loading element 106 (e.g., comprising printed copper) that extends vertically relative to the length of the chip antenna 104. The shaded area 110 represents part of the underlying circuit board's ground plane, with the area 112 representing a cutout for that ground plan for positioning the antenna element 104 and vertical loading element 106. Note that although not explicitly shown in FIG. 1 (and similarly not explicitly shown in FIGS. 2 or 3, described below), the shaded area 110 may continue under the copper segment shown to its right, and/or also may continue under the area marked 116.

Further represented in FIG. 1, generally within the dashed-lined oval 114, (the oval is used for highlighting, and is not actually a component) is a set of pads for matching circuit components. A feed point 116 (e.g., at fifty Ohms impedance) is also shown. More particularly, the microstrip trace on the top layer is usually fifty Ohms relative to the ground plane below it, (even though not exactly shown as such in FIG. 1 or analogously in FIGS. 2 or 3).

FIG. 2 shows a modified antenna circuit 202 including an additional loading element comprising further (e.g., printed copper) extension segments 205_{A}, 205_{B} and 205_{C} coupled to a top-loading antenna element portion 206 of the chip antenna 204. In this example, portions of the additional loading element (the extension segments 205_{A} and 205_{C}) are substantially orthogonal to the chip antenna element 204, but as will be understood, can be placed at any other angle, e.g., depending on a desired polar pattern. The additional loading element can also be bent in one or more places along its length, e.g., the leftward-extending portion is bent into two coupled segments 205_{A} and 205_{C} in the example represented in FIG. 2.

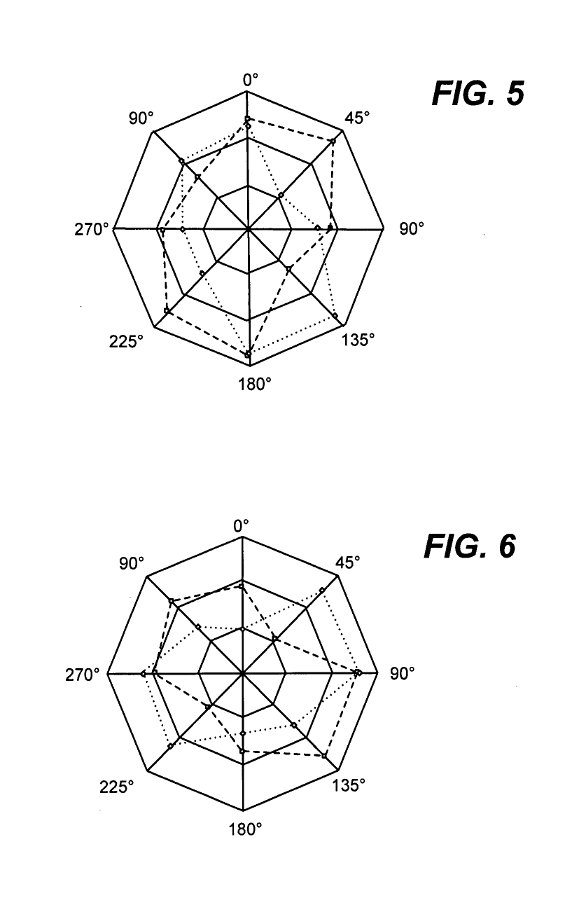

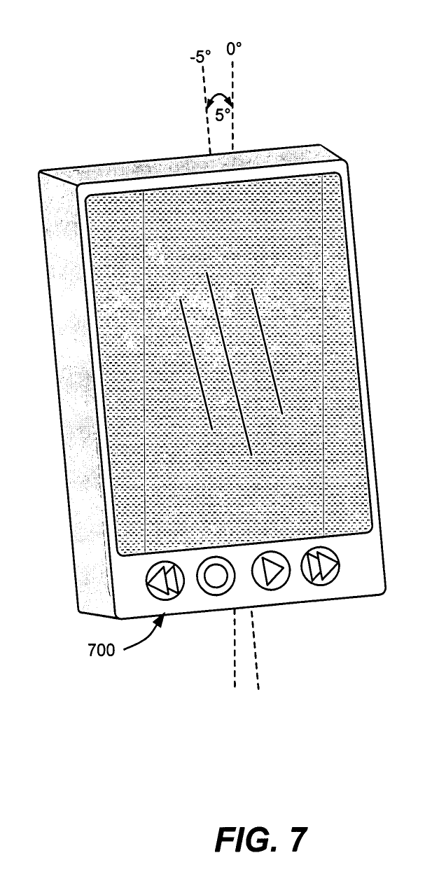

Further, as shown in the alternative antenna circuit 302 of FIG. 3, one or more additional segments, such as the segment 205_{D}, may be provided. Such segments can overlap another segment (e.g., 205_{B}), be angled still in another orientation, and so forth. As can be readily appreciated, there are a virtually unlimited number of possible configurations for element loading segments, and the ground plane will also be a factor in a given configuration. However, as shown below with reference to FIGS. 5 and 6, changing the loading with extensions comprising segments or other loading elements (e.g., curved portions) can indeed alter the polar radiation patterns.

As with FIG. 1, in FIG. 2 the shaded area 210 represents (part of) the underlying circuit board's ground plane; (again the shaded area 210 may continue under the copper segment shown to its right, and/or also may continue under the area marked 216). The area 212 represents a cutout for that ground plan for positioning the antenna chip element 204 with the loading element including the modified extension, comprising the segments 205_{A}, 205_{B} and 205_{C}, and vertical extension 206. Similarly, the dashed-lined oval 214 generally highlights a set of pads for matching circuit components, and a feed point 216 (e.g., at fifty ohms impedance) is also shown.

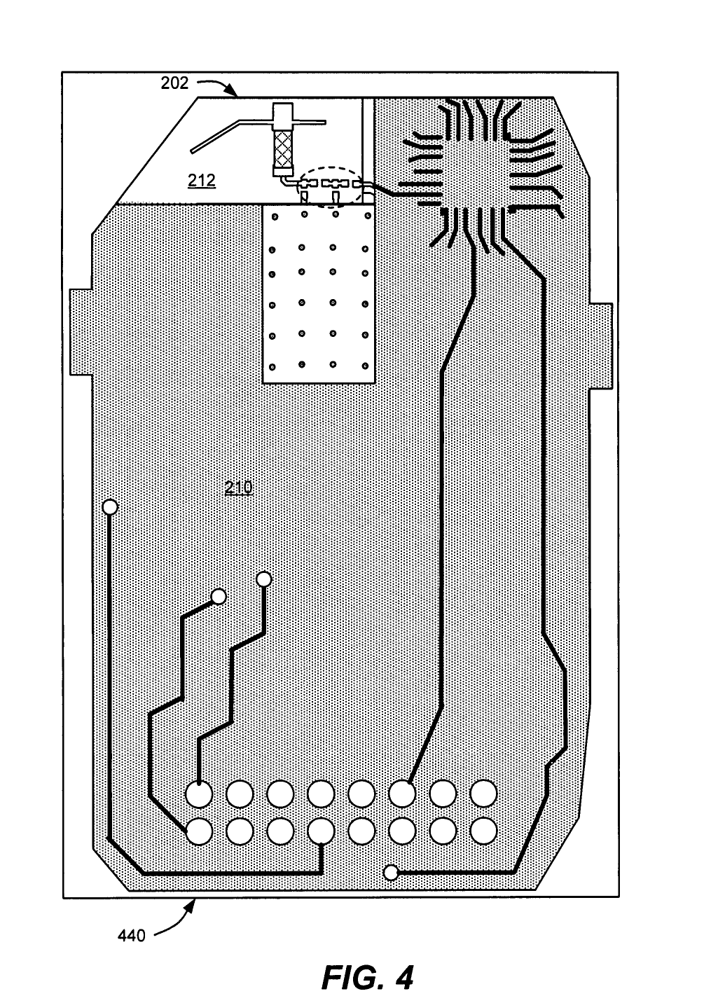

FIG. 4 shows the example modified antenna circuit 202 of FIG. 2 located on an example circuit board 440. As can be seen, the antenna circuit 202 is positioned in the area 212 cut out from the ground plane 210. Such an antenna element (or multiple such elements) alters the antenna polar pattern, that is, the modification to the loading element can significantly alter the gain polar pattern for the resulting antenna. For example, when metallic and\or dielectric bodies such as components, shield cans and plastic housings are placed close to an antenna element, these objects can alter or distort the field pattern around the antenna. The above-described modification (loading) techniques may be used to alter the antenna pattern to restore optimum gain and significantly improve device performance in a preferred product orientation. This can be advantageous for a handheld device where optimum physical orientation within the device cannot be guaranteed or may not otherwise be possible during normal use, as exemplified below.

FIGS. 5 and 6 demonstrate the effect of how the example modification technique of FIG. 2 relative to FIG. 1 changes the load and thus the polar radiation pattern. In general, FIG. 5 shows gain measurements taken at forty-five degree intervals (basically forming the octagons) with the antenna circuit positioned and rotated horizontally (e.g., the circuit board 440 is laid flat and rotated around the z-axis). In FIG. 5, the dotted line represents a trace for the configuration of FIG. 1 with no extra loading, and the dashed line represents a trace for the configuration of FIG. 2 with the additional loading resulting from the extensions 205_{A}, 205_{B} and 205_{C}. The closer to the center, the worse the gain; the octagons represent −5.0 dB increments from 0.0 dB to −15.0 dB, that is, the outermost octagon represents 0.0 dB, the center represents −15.0 dB.

As can be seen from the patterns in FIG. 5, when the board is measured at different angles while in the horizontal orientation, the dotted line corresponding to the configuration of FIG. 1 shows relatively poor gain from zero to ninety degrees, with a deep null at forty-five degrees. In contrast, the dashed line corresponding to the configuration of FIG. 2 shows relatively good gain from zero to ninety degrees.

The traces in FIG. 6 represent similar measurements to those of FIG. 5, except that the measurements of FIG. 6 were obtained by positioning the circuit board vertically (that is, the y-axis of the printed circuit board plane now points upward relative to a flat measuring surface). As can be seen, the dotted line represents the configuration shown in FIG. 1, which again shows relatively poor gain at zero degrees. The dashed line, representing the configuration shown in FIG. 2, has relatively good gain at zero degrees.

Thus, as can be seen, the additional antenna loading element represented in the circuit 202 of FIG. 2 has influenced the orientation of the printed circuit board at which maximum antenna gain is achieved; angular position of peak antenna gain can be adjusted using one or more such orthogonal and/or otherwise angled loading elements. In this example, maximizing gain at a zero degrees orientation was achieved, which, for example would be highly desirable for a media player that is normally held or positioned at close to zero degrees (whether laid flat or held upright) during normal viewing. A mobile telephone ordinarily positioned near a human cheekbone may require a different polar pattern. The examples were measured with a 2.45 Gigahertz antenna, but the concept of changing load via modified loading elements to change a polar radiation pattern is applicable to other frequency bands.

Proper selection of an antenna element configuration can thus adjust the antenna radiation pattern, to thereby minimize the depth of antenna gain nulls for a device in its normal usage orientation. This will result in improved quality of wireless links, giving higher data rate throughput and longer range. This concept can be applied to wirelessly-enabled music/video players, telephones with Bluetooth® or other wireless headset links or mobile devices.

### Exemplary Operating Environment

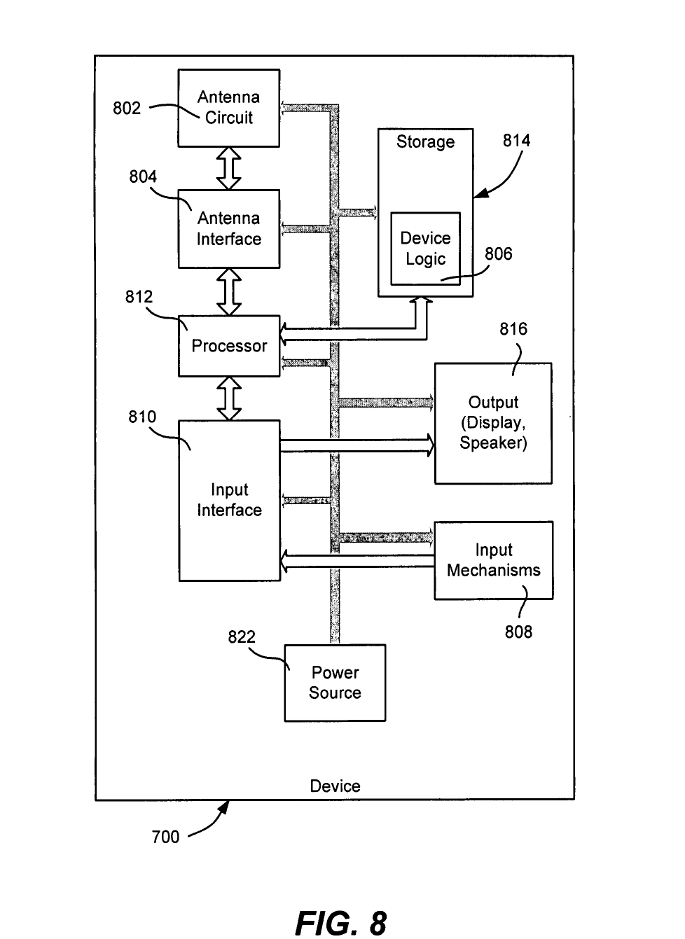

FIGS. 7 and 8 illustrate an example of a suitable computing device 700 on which the antenna circuit 202 of FIG. 2 may be implemented, for example. The computing device 700 is only one example of a suitable environment and is not intended to suggest any limitation as to the scope of use or functionality of the invention. Neither should the computing device 700 be interpreted as having any dependency or requirement relating to any one or combination of components illustrated herein.

In general, in FIG. 7, the example device 700 such as a video player is oriented at zero to minus five degrees for normal viewing operation. As such, (assuming for this example the same ground plane and other components), the example device 700 would benefit in gain from including the antenna circuit 202 of FIG. 2 rather than the antenna circuit 102 of FIG. 1.

For an exemplary environment, FIG. 8 shows an antenna circuit 802 coupled to an antenna interface 804, such as including one or more of a radio, amplifier, filter, matching circuitry, digitizer and/or the like. The antenna circuit 802 represents an antenna having a modified element to provide a particular polar gain pattern, and may be a chip antenna as described with reference to FIGS. 1-4, but alternatively may be a printed copper monopole antenna, a Planar Inverted-F (type) antenna, or the like.

Based on device logic 806 and user input via input mechanisms 808, such as buttons or the like coupled to an input interface 810, a processor 812 outputs video and/or audio from storage 814 to a display/speakers 816. The storage 814 may include volatile or non-volatile memory (e.g., flash memory and/or a hard disk), or some combination of both volatile and non-volatile memory.

In general, the antenna circuit 802 may be used for coupling the device 700 to a source of video (or audio), which need not be stored (except to possibly buffer) if live video is available for display. Also shown in FIG. 8 is a power source 822, such as a battery.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a communications environment, a system comprising:
an antenna, comprising a chip antenna, a monopole antenna, a meander line antenna, or a planar inverted-F (type) antenna; and
an antenna element coupled to the antenna, including at least one loading element portion that is not substantially parallel to the antenna.

2. The system of claim 1 wherein the antenna element includes at least one portion that is substantially orthogonal to the antenna.

3. The system of claim 1 wherein the antenna element includes a portion that is substantially parallel to the antenna, and at least one other portion that is substantially orthogonal to the antenna.

4. The system of claim 1 wherein the antenna element includes a portion that is substantially parallel to the antenna, and at least one other portion that is substantially orthogonal to the antenna.

5. The system of claim 1 wherein the antenna element is located on a printed circuit board that generally defines an x-y plane, and wherein the antenna and a first loading portion of the antenna element are generally parallel to the y-direction, a second loading portion of the antenna element comprises one segment generally in the negative x-direction, and a third loading portion of the antenna element comprises another segment generally in the positive y-direction.

6. The system of claim 5 wherein the antenna element further includes a fourth loading portion comprising a segment that extends partially in the negative or positive y-direction and partially in the negative or positive x-direction.

7. The system of claim 1 wherein the antenna element includes a first portion that is substantially orthogonal to the antenna, and a second portion coupled to the first portion that is bent at an angle relative to the second portion.

8. The system of claim 1 wherein the antenna element comprises a combination of one or more angled segments.

9. The system of claim 1 wherein the antenna comprises a chip antenna that is configured to operate at 2.45 Gigahertz.

10. The system of claim 1 wherein the antenna is coupled to a fifty ohm feed point.

11. The system of claim 1 wherein the antenna and antenna element are configured to provide polar patterns that have good gain when placed in a device that is oriented around zero degrees.

12. An antenna circuit, comprising, an antenna, and a loading element coupled to the antenna, the loading element including a top-loaded antenna portion or bottom-loaded antenna portion, that extends substantially parallel to the antenna, or both a top-loaded antenna portion and bottom-loaded antenna portion that extend substantially parallel to the antenna, and at least one other portion that extends in at least one direction that is nonparallel to the antenna.

13. The antenna circuit of claim 12 wherein the at least one other portion includes one or more segments that extend in a direction that is substantially orthogonal to the antenna.

14. The antenna circuit of claim 12 wherein the at least one other portion comprises two segments that are angled nonparallel to the antenna and are angled relative to each other.

15. The antenna circuit of claim 12 wherein the antenna comprises a chip antenna, and further comprising a circuit board on which the antenna circuit is located, and wherein the circuit board is incorporated into a mobile device.

16. In a mobile computing device, a system comprising:
a circuit board including a ground plane and a section insulated from the ground plane; and
an antenna circuit located on the section and coupled to the circuit board to provide radio frequency signal communication for the mobile computing device, the antenna circuit including an antenna and a loading element coupled to the antenna, the loading element including at least one portion that extends non-parallel to the antenna.

17. The system of claim 16 wherein the loading element includes a portion that extends parallel to the antenna.

18. The system of claim 17 wherein the at least one portion that extends non-parallel to the antenna includes a segment set, comprising at least one segment that is coupled to the portion that extends parallel to the antenna.

19. The system of claim 18 wherein the segment set extends substantially orthogonal in one direction relative to the portion that extends parallel to the antenna, and extends substantially orthogonal in an opposite direction relative to the portion that extends parallel to the antenna.

20. The system of claim 16 wherein the loading element includes at least one angled segment that is neither parallel nor orthogonal to the antenna.
